(19) United States
(12) Patent Application Publication
(10) Pub. No.: US 2017/0051682 A1
(43) Pub. Date: Feb. 23, 2017

(54) SYSTEM AND METHOD FOR ABATEMENT OF DYNAMIC PROPERTY CHANGES WITH PROACTIVE DIAGNOSTICS AND CONDITIONING

(71) Applicant: General Electric Company, Schenectady, NY (US)

(72) Inventors: James Arthur Simmons, Tampa, FL (US); Patrick Edward Pastecki, Pearland, TX (US)

(21) Appl. No.: 14/831,516

(22) Filed: Aug. 20, 2015

(51) Int. Cl. F02C 9/40; F02C 7/22; F02C 3/20

(52) U.S. Cl. CPC F02C 9/40; F02C 3/20; F02C 7/22

(57) ABSTRACT

A system includes a fluid transfer system that has instrumentation configured to measure fuel properties; a fluidic buffer volume device located downstream of a fuel sensing point, wherein the fluidic buffer volume device is configured to provide a residence time for the fuel within the fluidic buffer volume device to enable a signal representative of the fuel properties to be communicated to enable adjustment of operating conditions of a fuel consuming system as the fuel is provided; and a controller programmed to receive properties of the fuel consuming system, receive the signal, receive properties of the fluidic buffer volume device, and generate a time-resolved volumetric grid that characterizes fuel transport properties of the fuel for different flow conditions and times based on the properties of the fuel consuming system, the fuel properties, and the properties of the fluidic buffer volume device.

### BACKGROUND

The subject matter disclosed herein relates to systems and methods for fluid transfer and particularly for fuel transfer.

In systems where fuel is used or consumed over extended periods of time, such as certain power generation systems, there may be several sources of fuel that alternate providing fuel continuously to the system. These several sources of fuel may provide fuel that differ from one another in some characteristics. Sensors may detect these characteristics and provide the detected differences to the systems that utilize the fuel. In response to the different characteristics, the system may adjust operating settings to ensure proper or efficient use of fuel. Unfortunately, detecting the differences, sending the detected characteristics to the system, and/or adjusting the operating settings may take more time than it takes to transfer the fuel from the source to a fuel consuming system (e.g., a gas turbine engine). In other words, when using a fuel sensor as a guidance system to adjust a fuel schedule for the fuel consuming system, there can be brief intervals during a fuel flow rate change in which the fuel transport times shift in response to a change of fuel flow properties. These brief intervals may remain undetected by a fuel transfer system until after the events have impacted the performance of the fuel consuming system. This lagging perspective may introduce errors associated with differences between the reported fuel property values from the sensor and actual fuel properties traveling to the fuel consuming system.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In a first embodiment, a system includes a fluid transfer system that has instrumentation configured to measure one or more properties of a fuel. The fluid transfer system also includes a fluidic buffer volume device a located downstream of a fuel sensing point of the instrumentation, wherein the fluidic buffer volume device is configured to provide a residence time for the fuel within the fluidic buffer volume device to enable a signal from the instrumentation representative of an analysis of the one or more properties of the fuel to be communicated to enable adjustment of operating conditions of a fuel consuming system by a time that the fuel is provided to the fuel consuming system. The fluid transfer system further includes a controller programmed to receive one or more properties of the fuel consuming system, to receive the signal from the instrumentation representative of the one or more properties of the fuel, and to receive one or more properties of the fluidic buffer volume device, and to generate a time-resolved volumetric grid that characterizes fuel transport properties of the fuel for different flow conditions and flow times based at least on the one or more properties of the fuel consuming system, the one or more properties of the fuel, and the one or more properties of the fluidic buffer volume device.

In a second embodiment, a system includes a gas turbine engine controller. The gas turbine engine controller is programmed to receive one or more properties of a gas turbine engine. The gas turbine engine controller is further programmed to receive a signal from instrumentation representative of at least a lower heating value (LHV) and a specific gravity (SG) of a fuel acquired at a fuel sensing point located upstream of an inlet of a fluidic buffer volume device disposed upstream of a fuel metering system of the gas turbine engine. The gas turbine engine controller is also programmed to receive one or more properties of the fluidic buffer volume device. The gas turbine engine controller generates a time-resolved volumetric grid that characterizes fuel transport properties of the fuel for different flow conditions and flow times based at least on the one or more properties of the gas turbine engine, the LHV and the SG of the fuel, and the one or more properties of the fluidic buffer volume device. The gas turbine engine controller utilizes the time-resolved volumetric grid to provide a control signal to the fuel metering system with advanced knowledge of the fuel transport properties of the fuel to schedule consumption of the fuel within operational requirements of the gas turbine engine.

In a third embodiment, a method is provided that includes receiving, at a gas turbine engine controller, one or more properties of a gas turbine engine. The method also includes receiving, at the gas turbine engine controller, a signal from instrumentation representative of at least a lower heating value (LHV) and a specific gravity (SG) of a fuel acquired at a fuel sensing point located upstream of an inlet of a fluidic buffer volume device disposed upstream of a fuel metering system of the gas turbine engine. The method further includes receiving, at the gas turbine engine controller, one or more properties of the fluidic buffer volume device. The method still further includes generating, via the gas turbine engine controller, a time-resolved volumetric grid that characterizes fuel transport properties for different flow conditions and flow times of the fuel based at least on the one or more properties of the gas turbine engine, the LHV and the SG of the fuel, and the one or more properties of the fluidic buffer volume device. The method yet further includes utilizing, via the gas turbine engine controller, the time-resolved volumetric grid to provide a control signal to the fuel metering system.

### BRIEF DESCRIPTION OF THE DRAWINGS

These and other features, aspects, and advantages of the present subject matter will become better understood when the following detailed description is read with reference to the accompanying drawings in which like characters represent like parts throughout the drawings, wherein:

FIG. 1 is a schematic diagram of a fluid transfer system (e.g., a fuel transfer system);

FIG. 2 is a schematic diagram of a fuel transfer system in accordance with an embodiment;

FIG. 3 is a plot that illustrates a volumetric grid and a comparison of a reported fuel property value to an actual fuel property value over time of an instrumentation that has a low polling frequency that does not provide a direct link to a fuel transport time;

FIG. 4 is a plot that illustrates a volumetric grid and a comparison of a reported fuel property value to an actual fuel property value over time of an instrumentation that has a higher polling frequency that does not provide a direct link to a fuel transport time;

FIG. 5 is a plot that illustrates a time-resolved volumetric grid and a comparison of a reported fuel property value to an actual fuel property value over time of a fuel transfer system in accordance with an embodiment;

FIG. 6 is a plot 84 that illustrates a time-resolved volumetric grid and a comparison of a reported fuel property value to an actual fuel property value over time of a fuel transfer system using an analog signal in accordance with an embodiment;

FIG. 7 is a diagram illustrating how a fuel transfer system in accordance with an embodiment may act upon a sample of a fuel;

FIG. 8 is a plot of response times of various instrumentations and a fuel transfer system in accordance with an embodiment, and corresponding rates of change in fuel properties that may be tolerated by a fuel consuming system with an engineering tolerance to errors in the fuel properties of 1% and 5%; and

FIG. 9 is a flow chart illustrating an embodiment of a method for fuel transfer in accordance with an embodiment.

### DETAILED DESCRIPTION

One or more specific embodiments of the present subject matter will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is related to systems and methods for fluid (e.g., fuel) transfer and includes instrumentation configured to measure one or more properties of a fuel. The instrumentation may include a Wobbe Index Meter (WIM), a gas chromatograph, or any combination thereof. The one or more properties of the fuel may include lower heating value (LHV), specific gravity (SG), percent nitrogen, percent carbon dioxide, specific heat ratio, and compressibility. The fuel transfer systems and methods also include a fluidic buffer volume device a located downstream of a fuel sensing point of the instrumentation, wherein the fluidic buffer volume device is configured to provide a residence time for the fuel to enable a signal from the instrumentation representative of an analysis of the one or more properties of the fuel to be communicated to enable adjustment of operating conditions of a fuel consuming system as the fuel is provided to the fuel consuming system. In some embodiments, the signal may be an analog signal. In some embodiments, the fuel consuming system may include a gas turbine engine. The fuel transfer systems and methods further include a controller programmed to receive one or more properties of the fuel consuming system, to receive the signal from the instrumentation representative of the one or more properties of the fuel, and to receive one or more properties of the fluidic buffer volume device, and to generate a time-resolved volumetric grid that characterizes fuel transport properties of the fuel for different flow conditions and flow times based at least on the one or more properties of the fuel consuming system, the one or more properties of the fuel, and the one or more properties of the fluidic buffer volume device. The one or more properties of the fuel consuming system may include at least one of an engine speed, a load, an intake manifold air temperature, an exhaust gas recirculation temperature, a fuel characteristic, or any combination thereof. In some embodiments, the controller is configured to utilize the time-resolved volumetric grid to adjust operating conditions of the fuel consuming system. Advantageously, the disclosed embodiments provide a faster response time and access to greater allowable error percentage and rate of change capabilities for the fuel consuming system in comparison to the use of instrumentations not linked to the one or more properties of the fuel consuming system; the signal from the instrumentation representative of one or more properties of the fuel, and the one or more properties of the fluidic buffer volume device.

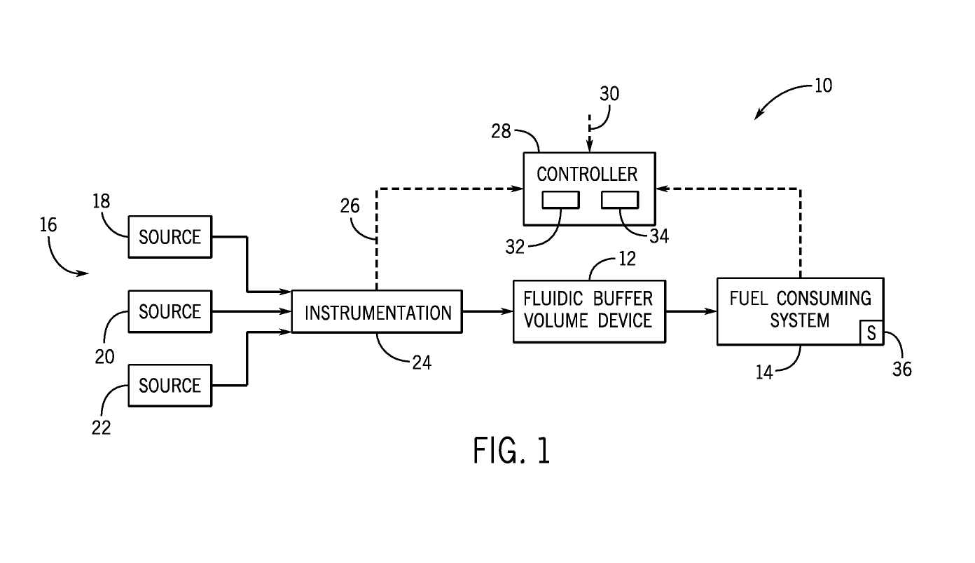

FIG. 1 is a schematic diagram of a fluid transfer system (e.g., a fuel transfer system 10). The fuel transfer system 10 also includes the fuel consuming system 14 and the fuel source 16. The fuel consuming system 14 may include any suitable system that uses or consumes a fuel, such as a gasifier, a furnace, a boiler, a reactor, an internal combustion engine, or others. In one embodiment, the fuel consuming system 14 may include a gas turbine system and the fuel may be gas and/or liquid fuel. The fuel source 16 may provide any number of fuels such as other feedstock to the fuel consuming system 14. In some embodiments, the fuel consuming system 14 uses fuel from the fuel source 16 continuously over a period of time, such that all the fuel from a first fuel source 18 is consumed. In such an instance, fuel from a second fuel source 20 or additional fuel sources 22 is administered to the fuel consuming system 14. The fuel from the second fuel source 20 or the additional fuel sources 22 may differ from the fuel in the first fuel source 18, and from one another. For example, the first fuel source 18 may contain fuel that includes different fuel properties, such as lower heating value (LHV), specific gravity (SG), percent nitrogen, percent carbon dioxide, specific heat ratio, and compressibility, than fuel from the second fuel source 20.

The fuel transfer system 10 includes instrumentation 24, such as sensors, to monitor and analyze the composition of the fuel upstream of the fluidic buffer volume device 12 and convey a signal 26 to additional instrumentation such as a controller 28 (e.g., a computer-based controller) that has a processor 32, a memory 34, and executable code. The processor 32 may be any general purpose or application-specific processor. The memory 34 may include one or more tangible, non-transitory, machine-readable media. By way of example, such machine-readable media can include RAM, ROM, EPROM, EEPROM, CD-ROM, or other optical disk storage, magnetic disk storage or other magnetic storage devices, or any other medium which can be used to carry or store desired program code in the form of machine-executable instructions or data structures and which can be accessed by a processor (e.g., the processor 32) or by any general purpose or special purpose computer or other machine with a processor (e.g., the processor 32). The signal 26 may include information representing detection by the instrumentation 24 of a transient event (i.e., transient composition change in fuel properties), where fuel entering the volume buffer switches from one source (e.g., source 18) to another source (e.g., source 20). For example, the fuel may transition from a fuel with a first set of fuel properties, including composition, pressure, temperature, heating value, viscosity, or other property, to a fuel with a second set of fuel properties, wherein one or more fuel properties in the second set may be different than one or more fuel properties in the first set. The controller 28 may adjust the operating settings of the fuel consuming system 14 based upon the information contained in signal 26 detected by the instrumentation 24. The controller 28 may also adjust the operating settings based on other inputs 30, such as inputs from an operator. The controller 28 may use a period of time to read the signals, process the signals, adjust the operating settings, or any combination thereof, to increase efficiency and maintain operational integrity during the transient event (e.g., switching from the first source 18 to the second source 20 or additional sources 22).

The fluidic buffer volume device 12 extends the fuel flow path from the source 16 over a tortuous path between walls of adjacent tubes, so that the controller 28 has time to make adjustments to the fuel consuming system 14 before the fuel reaches the fuel consuming system 14. The fluidic volume device 12 is also configured to maintain the properties of the fuel such that the properties of the fuel remain virtually unchanged. The fuel consuming system 14 may include one or more fuel consuming system sensors 36 that measure properties of the fuel consuming system 14. The one or more fuel consuming system sensors 36 may further include, without limitation, atmospheric and engine sensors (e.g., pressure sensors, temperature sensors, speed sensors, etc.), NO_{X} sensors, oxygen or lambda sensors, engine air intake temperature sensors, engine air intake pressure sensors, jacket water temperature sensors, exhaust gas recirculation (EGR) flow rate sensors, EGR temperature sensors, EGR inlet pressure sensors, EGR valve pressure sensors, EGR temperature sensors, EGR valve position sensors, engine exhaust temperature sensors, engine exhaust pressure sensors, and compressor inlet and outlet sensors for temperature and pressure.

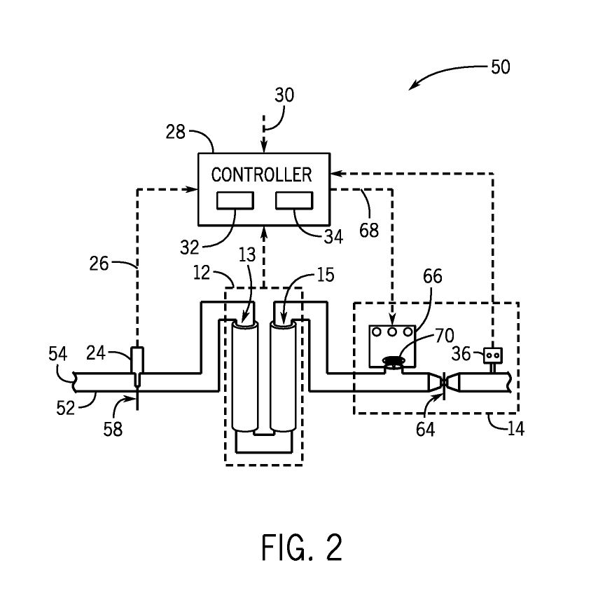

FIG. 2 is a schematic diagram of a fuel transfer system 50 in accordance with an embodiment. The fuel transfer system 50 includes a pipe 52 which is used to transfer a fuel 54, such as gas and/or liquid fuel. The fuel 54 may be provided by one or more fuel sources 16 (not shown) as described above. The fuel transfer system 50 includes instrumentation 24 that is configured to measure one or more properties of the fuel 54 at a fuel sensing point 58 of the instrumentation 24. By way of a non-limiting example, the instrumentation 24 may include a Wobbe Index Meter (WIM), a gas chromatograph, or any combination thereof. By way of a non-limiting example, the one or more properties of the fuel 54 measured by the instrumentation 24 may include lower heating value (LHV), specific gravity (SG), percent nitrogen, percent carbon dioxide, specific heat ratio, compressibility, or any combination thereof.

A fluidic buffer volume device 12 may be located downstream of the fuel sensing point 58. The fluidic buffer volume device 12 may be configured to provide a residence time for the fuel within the fluidic buffer device 12 to enable a signal 26 from the instrumentation 24 representative of an analysis of the one or more properties of the fuel 54 measured at the fuel sensing point 58 to be communicated to enable adjustment of operating conditions of a fuel consuming system 14 as the fuel 54 is provided to the fuel consuming system 14, such as a gas turbine. The fluidic buffer volume device 12 may be configured to maintain the properties of the fuel 54 such that the properties of the fuel 54 remain virtually unchanged between the fuel sensing point 58 and the fuel consumption point 64. In this manner, the one or more properties of the fuel 54 may not be distorted when the fuel reaches the fuel consumption point 64. For example, the residence time of the signal 26 may be buffered by the time it takes the fuel 54 to travel the volume of the fluidic buffer device 12 so that the analysis of the one or more properties of the fuel 54 reported are representative of the fuel 54 at the fuel consumption point 64. In one embodiment, the fluidic buffer volume device 12 is configured to reproduce the transient event occurring upstream of an inlet of the fluidic buffer volume device 12 (e.g., by measuring the one or more properties of the fuel 54 measured at the fuel sensing point 58 by the instrumentation 24) in the fuel downstream of the outlet 15 after the fuel travels along a fuel flow path through the fluidic buffer volume device 12 (e.g., at fuel consumption point 64).

It may be desirable to send the signal 26 representative of the analysis of the one or more properties of the fuel 54 measured at the fuel sensing point 58 as an analog signal. The analog signal may be considered a more representative depiction of the one or more properties of the fuel 54 because the analog signal may represent an instantaneous profile of the one or more properties of the fuel 54, transposed a corresponding time period being measured at the fuel sensing point 58 by the instrumentation 24. That is, the analog signal may be able to accurately imitate the smooth S-shaped curved behavior of the one or more properties of the fuel 54. A digital signal, on the other hand, may not be able to provide the instantaneous profile of the one or more properties of the fuel 54. Instead, the digital signal may send a lagging series of digital steps that replace the smooth profile available with the analog signal. As a result, the digital signal may introduce a greater degree of error into the signal 26.

The embodiment of the fuel transfer system 50 illustrated in FIG. 2 may include a controller 28 programmed to receive the one or more properties of the fuel consuming system 14, the signal 26 from the instrumentation 24 representative of the one or more properties of the fuel 54, and one or more properties of the fluidic buffer volume device 12. The controller 28 may also accept input signals 30 from the operator. By way of a non-limiting example, the one or more properties of the fuel consuming system 14 may include, without limitation, engine speed, load, intake manifold air temperature, EGR temperature, fuel characteristics (e.g., lower heating value and/or Waukesha knock index), or any combination thereof. The one or more properties of the fuel consuming system 14 may be measured by the one or more fuel consuming system sensors 36 which may include, without limitation, atmospheric and engine sensors (e.g., pressure sensors, temperature sensors, speed sensors, etc.), NO sensors, oxygen or lambda sensors, engine air intake temperature sensors, engine air intake pressure sensors, jacket water temperature sensors, exhaust gas recirculation (EGR) flow rate sensors, EGR temperature sensors, EGR inlet pressure sensors, EGR valve pressure sensors, EGR temperature sensors, EGR valve position sensors, engine exhaust temperature sensors, engine exhaust pressure sensors, and compressor inlet and outlet sensors for temperature and pressure. By way of a non-limiting example, the one or more properties of the fuel 54 represented by signal 26 may include lower heating value (LHV), specific gravity (SG), percent nitrogen, percent carbon dioxide, specific heat ratio, compressibility, or any combination thereof. By way of a non-limiting example, the one or more properties of the fluidic buffer volume device 12 may include an effective volume of the fluidic buffer volume device 12, a transport time from the fuel sensing point 58 to a fuel consumption point 64, or any combination thereof.

Some embodiments may program the controller 28 to generate a time-resolved volumetric grid that characterizes fuel transport properties of the fuel 54 for different flow conditions and flow times based at least on the one or more properties of the fuel consuming system 14, the signal 26, and the one or more properties of the fluidic buffer volume device 12. For example, the volumetric grid may provide a volumetric resolution for the instrumentation 24. The volumetric resolution may be defined as a product of a volumetric flow rate of the fuel consuming system 14 (e.g., a gas turbine engine) and a time period that it takes for a sample of fuel to be extracted, transported, measured, and reported by the instrumentation 24 for a given set of operating conditions.

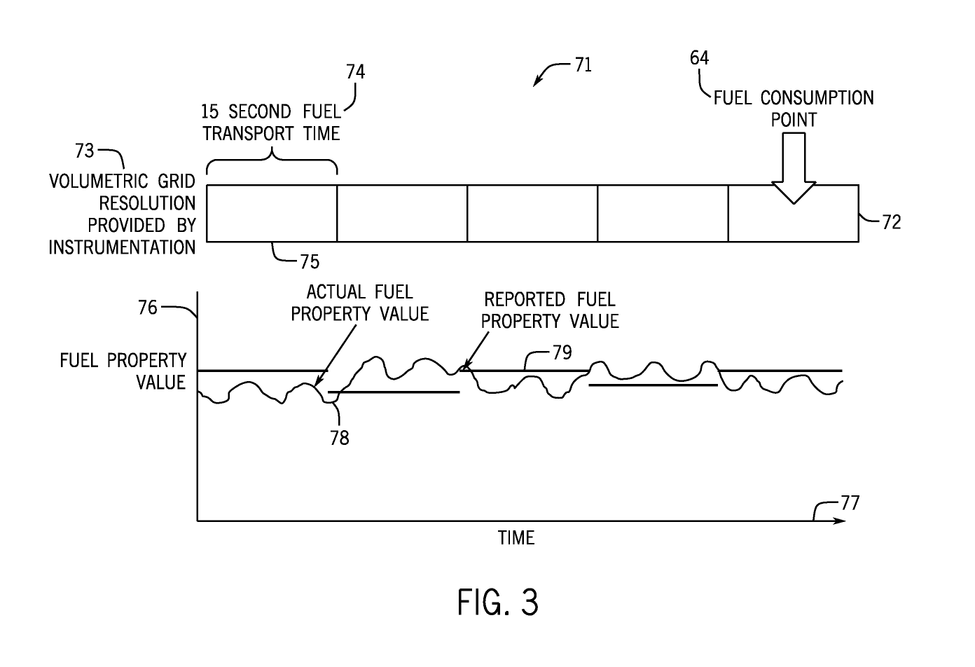

With the foregoing in mind, FIG. 3 is a plot 71 that illustrates a volumetric grid 72 that is not time-resolved and a comparison of a reported fuel property value 79 to an actual fuel property value 78 over time 77 of an instrumentation 24 that has a low polling frequency 75, such as the gas chromatograph. The volumetric grid 72 is not time-resolved in that it does not provide a direct link to a fuel transport time 74 (e.g., the time it takes a sample of fuel 54 to travel from the fuel sensing point 58 to the fuel consumption point 64) of the fuel transfer system 50 (i.e., through the use of the fluidic buffer volume device 12 and receiving the one or more properties of the fuel consuming system 14, the one or more properties of the fuel 54, and the one or more properties of the fluidic buffer volume device 12). The gas chromatograph may be a commercially available chemical analyzer that can separate chemicals in a complex sample, such as the sample of fuel 54. The gas chromatograph relies on a functional material coated on the inside of a column which produces different residence times for various compounds being analyzed in the sample. While this technique is highly accurate, it is also slower in comparison to other techniques (e.g., the WIM). The gas chromatograph has a long response time 80 for reporting measurements of gas properties (e.g., approximately 180-300 seconds), and thus a low polling frequency. The polling frequency of the instrumentation 24 reflects how often the instrumentation 24 may take a measurement, and consequently report its findings. The higher the polling frequency for the instrumentation 24, the higher the volumetric resolution of the one or more fuel property values reported 79 by the instrumentation 24. In this example, the instrumentation 24 has a polling frequency 75 of 15 seconds.

The instrumentation 24 may provide a defined volumetric resolution 73 of the one or more fuel property values reported 79 for a sample of fuel 54, but most likely after it has been consumed. The fuel property value 76 represents a value of the one or more properties of the fuel 54, which may include lower heating value (LHV), specific gravity (SG), percent nitrogen, percent carbon dioxide, specific heat ratio, and compressibility. This is because the instrumentation 24 will typically report lagging fuel property values 79 due to the lack of the direct link to the fuel transport time 74. In particular, the reported fuel property value 79 lags behind the actual fuel property value by a time period equal to the fuel transport time 74. Because the fuel transport time 74 is 15 seconds, and the fluidic buffer volume device 12 is not utilized, the signal will lag by approximately 15 seconds. In the best case, the one or more fuel property values are reported 79 prior to consumption of the sample of fuel 54, though with limited value because there is no direct link to the fuel transport time 74. The limitations of the instrumentation 24 in FIG. 3 include the coarse volumetric resolution 73 and the lagging report of fuel property values 79 driven by the fuel transport time 74, which may fail to accurately represent the one or more properties of the fuel 54 when consumed at the fuel consumption point 64 by the fuel consuming system 14 (e.g., a gas turbine engine).

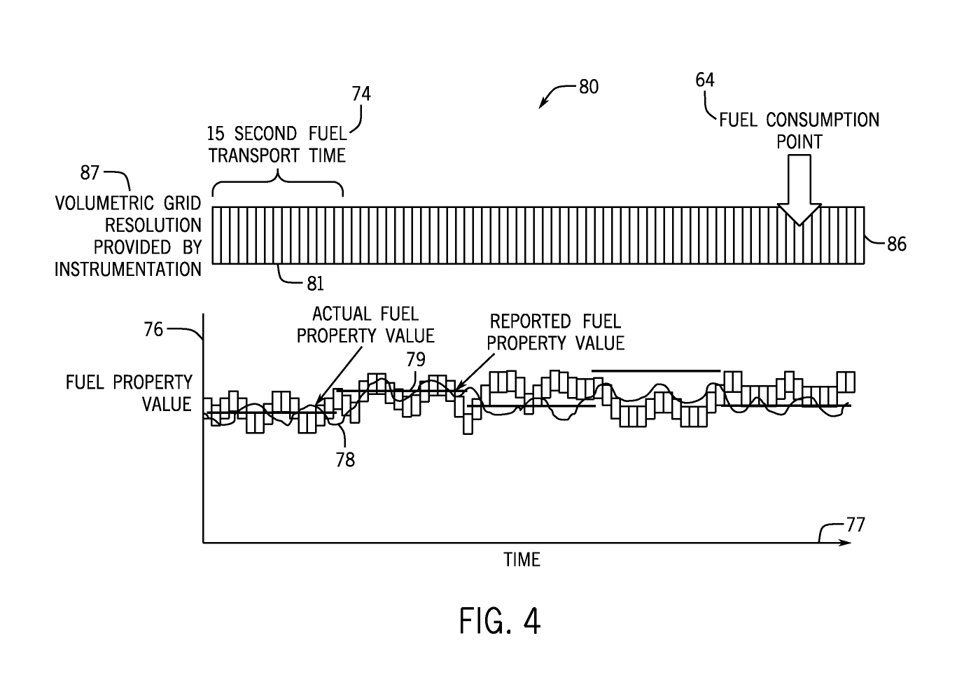

Turning now to FIG. 4, a plot 80 that illustrates the volumetric grid 86 that is not time-resolved and a comparison of the reported fuel property value 79 to the actual fuel property value 78 over time 77 of an instrumentation 24 that has a higher polling frequency 81, such as the WIM or the gas chromatograph used in conjunction with the WIM. The volumetric grid 86 is not time-resolved in that it does not provide a direct link to the fuel transport time 74 (i.e., the time it takes a sample of fuel 54 to travel from the fuel sensing point 58 to the fuel consumption point 64) of the fuel transfer system 50 (i.e., through the use of the fluidic buffer volume device 12 and receiving the one or more properties of the fuel consuming system 14, the one or more properties of the fuel 54, and the one or more properties of the fluidic buffer volume device 12). The WIM is a flameless calorimeter that may output, for example, a Wobbe index (an indicator of the interchangeability of fuel gases), a combustion air requirement index, LHV, and/or SG. The WIM uses a residual oxygen sensor to approximate fuel properties. The WIM has a significantly shorter response time (e.g., approximately 10 seconds) than the gas chromatograph. The polling frequency 81 of the instrumentation 24 in FIG. 4 is higher than the polling frequency 75 instrumentation 24 in FIG. 3. As a result, the instrumentation 24 in FIG. 4 will provide a higher volumetric resolution than the instrumentation 24 in FIG. 3. In this example, the instrumentation 24 has a polling frequency 81 of 1 second.

The instrumentation 24 may provide a defined volumetric resolution 87 of the one or more reported fuel property values 79 for a sample of fuel 54, but most likely after it has been consumed. This is because the instrumentation 24 may still report lagging fuel property values 79 because of the assumed static volumetric resolution driven by the fuel transport time 74. While the volumetric resolution is an improvement over less responsive instrumentations 24 (such as the instrumentation 24 in FIG. 3), it is still unlinked to the fuel transport time 74 and thereby still may be prone to introducing error in the reported fuel property values 79. During a change in volumetric flow as a function or change in load demand, composition of the fuel 54, or a combination of the two, the instrumentation 24 may not be able to compensate for a dynamic volumetric resolution and may thus further confound the reported fuel property values 79 of the sample of fuel 54. Despite these limitations, the higher polling frequency is an improvement from the lower polling frequency of the instrumentation 24 in FIG. 3.

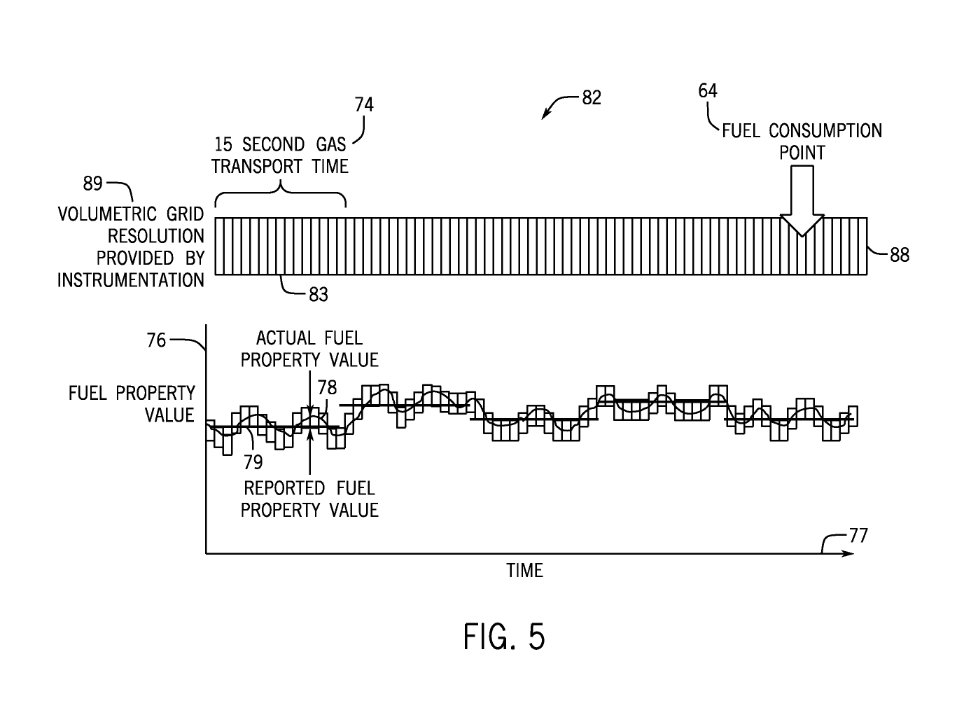

Turning now to FIG. 5, a plot 82 that illustrates a time-resolved volumetric grid 88 and a comparison of the reported fuel property value 79 to the actual fuel property value 78 over time 77 of the fuel transfer system 50 in accordance with an embodiment. Specifically, the fuel transfer system 50 includes an instrumentation 24 that has the same polling frequency 83 as the instrumentation 24 in FIG. 4, such as the WIM or the gas chromatograph used in conjunction with the WIM, and provides a direct link to the fuel transport time 74 (i.e., the time it takes a sample of fuel 54 to travel from the fuel sensing point 58 to the fuel consumption point 64) of the fuel transfer system 50 (i.e., through the use of the fluidic buffer volume device 12 and receiving the one or more properties of the fuel consuming system 14, the one or more properties of the fuel 54, and the one or more properties of the fluidic buffer volume device 12). Utilizing the direct link to the fuel transport time 74 eliminates the lag that would be otherwise present in the report of the fuel property values 79 and provides the fuel transport time 74 of the sample of fuel 54. This is achieved only when a sufficient volume is available between the fuel sensing point 58 and the fuel consumption point 64 (i.e., in the fluidic buffer volume device 12) such that there is sufficient time to report the fuel property values 79 prior to consumption of the sample of fuel 54. Thus, the instrumentation 24 realizes the advantages of the higher resolution 89 volumetric grid 88 because of its higher polling frequency 83 and elimination of the lag that would be otherwise present in the report of the fuel property values 79. As a result, the controller 28 may have sufficient time to appropriately adjust operating settings through the fuel metering system 66 to ensure proper and efficient use of the fuel 54 and avoid delaying operation of or damage to the fuel consuming system 14.

The controller 28 may also be configured to utilize the time-resolved volumetric grid 88 to adjust operating conditions of the fuel consuming system 14. For example, the controller 28 may be configured to receive the load of the fuel consuming system 14, the effective volume of the fluidic buffer volume device 12, and at least the LHV and the SG of the fuel 54 from the signal 26. The controller 28 may be further configured to generate the time-resolved volumetric grid 88 based on the load of the fuel consuming system 14, the effective volume of the fluidic buffer volume device 12, and at least the LHV and the SG of the fuel 54.

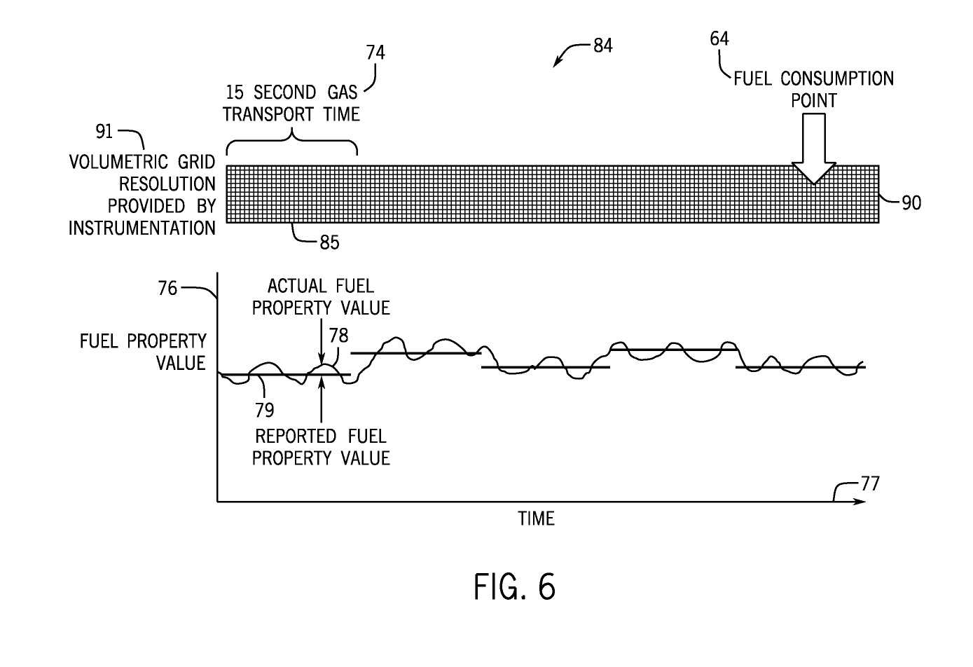

With the foregoing in mind, FIG. 6 is a plot 84 that illustrates the time-resolved volumetric grid 90 and a comparison of the reported fuel property value 79 to the actual fuel property value 78 over time 77 of the fuel transfer system 50 in accordance with an embodiment. Specifically, the fuel transfer system 50 includes an instrumentation 24, such as the WIM or the gas chromatograph used in conjunction with the WIM, that may send the signal 26 representative of the analysis of the one or more properties of the fuel 54 measured at the fuel sensing point 58 as an analog signal, that provides a direct link to the fuel transport time 74 (i.e., the time it takes a sample of fuel 54 to travel from the fuel sensing point 58 to the fuel consumption point 64) of the fuel transfer system 50 (i.e., through the use of the fluidic buffer volume device 12 and receiving the one or more properties of the fuel consuming system 14, the one or more properties of the fuel 54, and the one or more properties of the fluidic buffer volume device 12). Utilizing the direct link to the fuel transport time 74 eliminates the lag that would be otherwise present in the report of the fuel property values 79 and provides the fuel transport time 74 of the sample of fuel 54. Utilizing the analog signal 26 may enable an even higher polling frequency 85, and thus higher volumetric resolution 91, to be realized from the instrumentation 24. This is because a virtually continuous stream of data due to the higher polling frequency 88 over time 77 provides a greater number of measured fuel property values. In effect, the higher resolution 91 time-resolved volumetric grid 90 may enable an accurate mapping of rapid transient fuel composition change in the fuel transfer system 50 that the instrumentation 24 without use of the analog representation of the signal 26 may be incapable of reproducing. As a result, the controller 28 may have sufficient time to appropriately adjust operating settings through the fuel metering system 66 to ensure proper and efficient use of the fuel 54 and avoid delaying operation of or damage to the fuel consuming system 14.

The controller 28 may also be configured to utilize the time-resolved volumetric grid 90 to adjust operating conditions of the fuel consuming system 14. For example, the controller 28 may be configured to receive the load of the fuel consuming system 14, the effective volume of the fluidic buffer volume device 12, and at least the LHV and the SG of the fuel 54 from the signal 26. The controller 28 may be further configured to generate the time-resolved volumetric grid 90 based on the load of the fuel consuming system 14, the effective volume of the fluidic buffer volume device 12, and at least the LHV and the SG of the fuel 54.

In one embodiment, the controller 28 (e.g., a gas turbine engine controller) is programmed to receive one or more properties of a fuel consuming system 14 (e.g., a gas turbine engine), a signal 26 from instrumentation 24 representative of at least the LHV and the SG of a fuel 54 acquired at a fuel sensing point 58, and one or more properties of a fluidic buffer volume device 12. The signal 26 may be representative of at least the LHV and the SG of the fuel 54 as it exits an outlet 15 of the fluidic buffer volume device 12 into the fuel metering system 66 of the fuel consuming system 14. As discussed above, the signal 26 may be an analog signal. The signal 26 may additionally be representative of a percent nitrogen, percent carbon dioxide, specific heat ratio, compressibility of the fuel, or any combination thereof. The instrumentation may include a Wobbe Index Meter (WIM), a gas chromatograph, or any combination thereof. The fuel sensing point 58 is located upstream of the inlet 13 of the fluidic buffer volume device 12, which itself is disposed upstream of the fuel metering system 66 of the fuel consuming system 14.

The controller 28 is also programmed to generate the time-resolved volumetric grid that characterizes fuel transport properties of the fuel 54 for different flow conditions and flow times based at least on the one or more properties of the fuel consuming system 14, the LHV and the SG of the fuel 54, and the one or more properties of the fluidic buffer volume device 12. The controller 28 may utilize the time-resolved volumetric grid to provide a control signal 68 to the fuel metering system 66. The fuel metering system 66 enables adjustment of operating settings to ensure proper or efficient use of the fuel 54 and may include a fuel metering valve 70. In one embodiment, the controller 28 is configured to utilize the time-resolved volumetric grid to provide the control signal 68 to set a position of the fuel metering valve 70. The one or more properties of the fluidic buffer volume device 12 may include an effective volume of the fluidic buffer volume device 12, a transport time from the fuel sensing point 58 to a fuel consumption point 64, or any combination thereof.

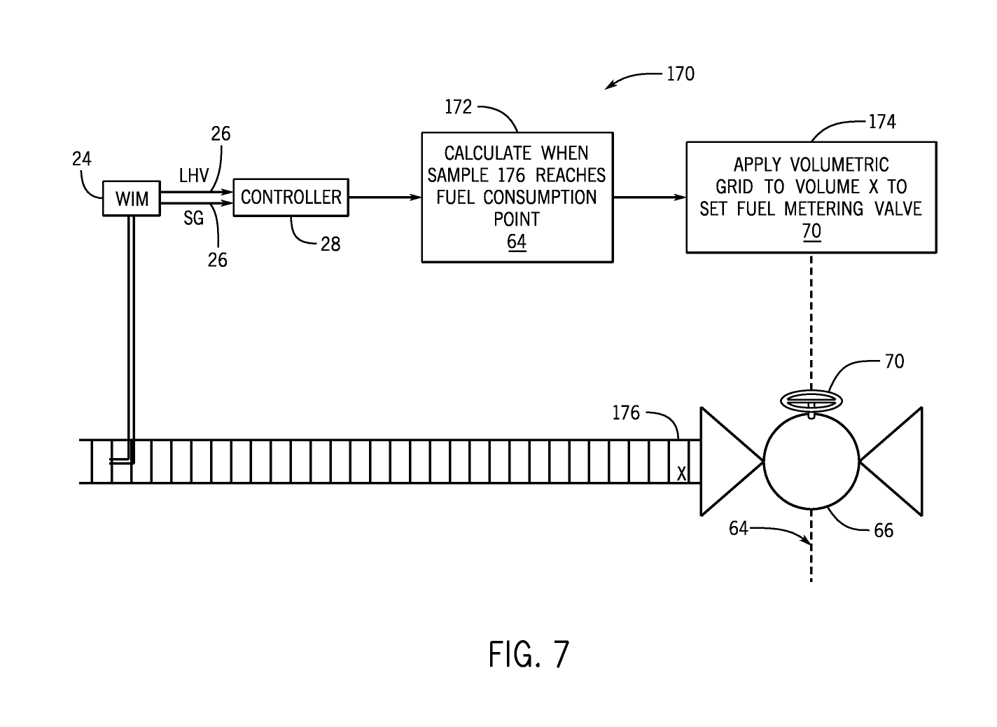

FIG. 7 is a diagram 170 illustrating how the fuel transfer system 50 in accordance with an embodiment may act upon a sample 176 of the fuel 54. Specifically, the instrumentation 24 (e.g., the WIM) measure one or more properties (e.g., the LHV and the SG) of the sample 176 of the fuel 54. The instrumentation 24 sends the signal 26 to the controller 28 that includes the LHV and the SG of the sample 176 of the fuel 54. The controller 28 may then calculate 172 when the sample 176 of the fuel 54 will reach the fuel consumption point 64 based on the one or more properties of the fuel consuming system 14, the one or more properties of the fuel 54, and the one or more properties of the fluidic buffer volume device 12. The controller 28 may apply 174 the time-resolved volumetric grid to the sample 176 of the fuel 54 to set the fuel metering valve 70 for efficient operation of the fuel consuming system 14. In effect, the fuel transfer system 50 is able to document the one or more properties of the fuel 54 and their scheduled transport time for arrival at the fuel consumption point 64 based on a set of dynamic variables, including the one or more properties of the fuel consuming system 14, the one or more properties of the fuel 54, and the one or more properties of the fluidic buffer volume device 12. The result is that the fuel transfer system 50 provides a high accuracy in actual and reported fuel values that is not achievable from conventional instrumentations 24 (e.g., the gas chromatograph or the WIM) alone. For example, a gas turbine engine that has an 18,000 pound per hour mass flow rate of fuel 54 with an engineering tolerance to errors in reported fuel properties of ±1.5% by point, will approximate a 5% error in reported fuel properties for the gas chromatograph. For the WIM, the error is reduced to approximately 0.3% error for the same for rate of fuel 54. For the fuel transfer system 50, the error is further reduced to approximately 0.02%.

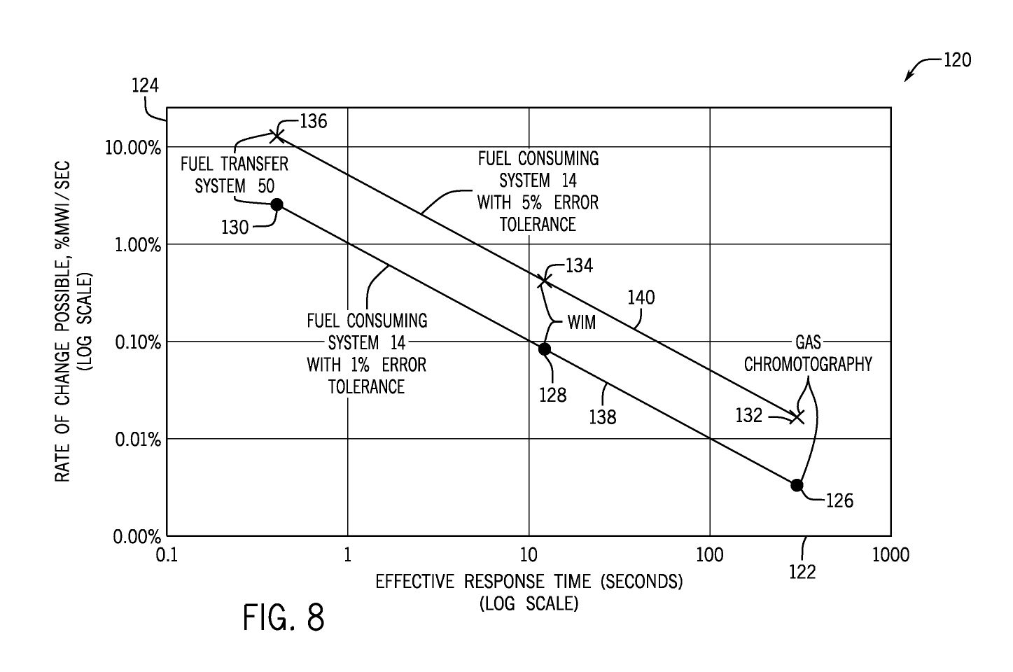

Typical fuel consuming system 14 controls software may compensate for a small error percentage up to a certain threshold in certain fuel properties, such as the LHV and the SG, avoiding any significant impact to combustor operability or exhaust emissions. When the error is beyond the threshold, high combustor acoustics or blowout and significant power shifts may result until the measured LHV and the measured SG catch up with the actual values of the fuel at the fuel consumption point 64. For example, FIG. 8 is a plot 120 of response times of various instrumentations 24 and the fuel transfer system 50 in accordance with an embodiment, and corresponding rates of change in fuel properties that may be tolerated by the fuel consuming system 14, such as a gas turbine engine, with an engineering tolerance to errors in the fuel properties of 1% and 5%. The engineering tolerance to error of the fuel consuming system 14 and the response times of the various instrumentations 24 and the fuel transfer system 50 dictate the entitlement rate of change in fuel properties (e.g., the LHV, the SG, etc.) that can be safely negotiated. The horizontal axis 122 of the plot 120 represents the effective response time in seconds. The vertical axis 124 represents the rate of change in fuel properties possible in Modified Wobbe Index percentage (referencing an MWI of 52) per second, using a log scale. Assuming the fuel consuming system 14 has a 1% error tolerance 138, the gas chromatograph 126 may have an effective response time of approximately 300 seconds and an allowable rate of change in fuel properties of approximately 0.002% per second with respect to the fuel consuming system 14 and the volumetric resolution of the fuel properties available by gas chromatograph. The WIM 128 may have an effective response time of approximately 10 seconds and an allowable rate of change in fuel properties of approximately 0.08% per second with respect to the fuel consuming system 14 and the volumetric resolution of the fuel properties available by the WIM. The fuel transfer system 50 (data point 130) may have an effective response time of approximately 0.4 seconds and an allowable rate of change in fuel properties of approximately 3% per second with respect to the fuel consuming system 14 and the volumetric resolution of the fuel properties available by the fuel transfer system 50. Therefore, the fuel transfer system 50 not only provides a much faster response time, but also provides access to improved volumetric resolution of the fuel properties that enables a greater fuel property rate of change capabilities for the fuel consuming device 14.

The error tolerance of the fuel consuming system 14 may have a significant factor in the overall rate of change capability 124. In particular, the fuel consuming system 14 with greater engineering tolerances may provide for greater error tolerance in the reported fuel property values, which in turn may provide for an overall greater rate of change capability because of the reduced requirement for signal 26 accuracy. For example, assuming the fuel consuming system 14 has a 5% error tolerance 140, the gas chromatograph 132 may have an effective response time of approximately 300 seconds and an allowable rate of change in fuel properties of approximately 0.02% per second with respect to the fuel consuming system 14 and the volumetric resolution of the fuel properties available by gas chromatograph. The WIM 134 may have an effective response time of approximately 10 seconds and an allowable rate of change in fuel properties of approximately 0.4% per second with respect to the fuel consuming system 14 and the volumetric resolution of the fuel properties available by the WIM. The fuel transfer system 50 (data point 136) may have an effective response time of approximately 0.4 seconds and an allowable rate of change in fuel properties of approximately 10% per second with respect to the fuel consuming system 14 and the volumetric resolution of the fuel properties available by the fuel transfer system 50. Again, the fuel transfer system 50 not only provides a much faster response time, but also provides access to improved volumetric resolution of the fuel properties that enables a greater fuel property rate of change capabilities for the fuel consuming device 14. Moreover, the increased error tolerance of the fuel consuming system 14 enables an overall greater rate of change capability because of the reduced requirement for signal 26 accuracy.

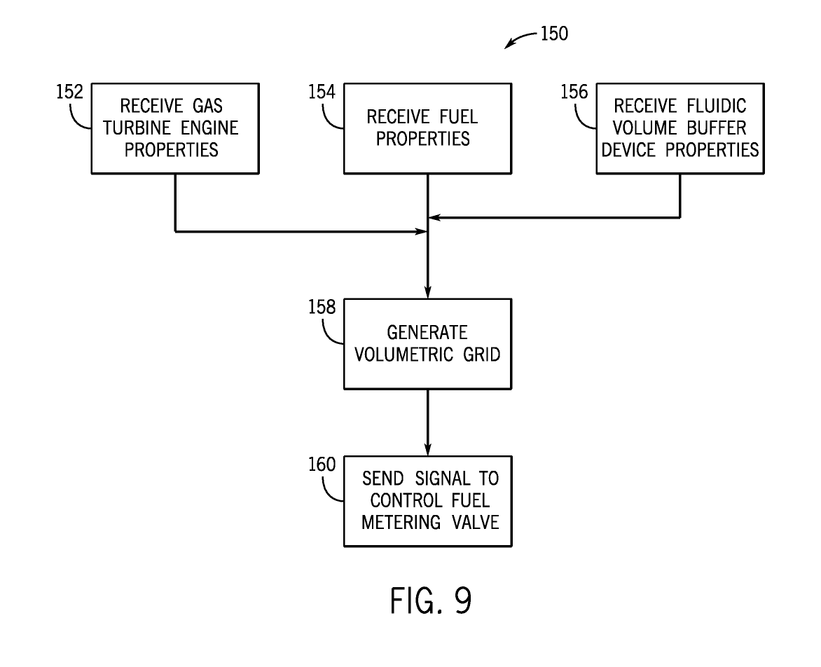

FIG. 9 is a flow chart 150 illustrating an embodiment of a method for fuel transfer in accordance with the present disclosure. The controller 28 (e.g., the gas turbine engine controller) receives (block 152): the one or more properties of the fuel consuming system 14 (e.g., the gas turbine engine). By way of a non-limiting example, the one or more properties of the fuel consuming system 14 may include, without limitation, engine speed, load, intake manifold air temperature, EGR temperature, fuel characteristics (e.g., lower heating value and/or Waukesha knock index), or any combination thereof. The one or more properties of the fuel consuming system 14 may be measured by the one or more fuel consuming system sensors 36 which may include, without limitation, atmospheric and engine sensors (e.g., pressure sensors, temperature sensors, speed sensors, etc.), NO_{X} sensors, oxygen or lambda sensors, engine air intake temperature sensors, engine air intake pressure sensors, jacket water temperature sensors, exhaust gas recirculation (EGR) flow rate sensors, EGR temperature sensors, EGR inlet pressure sensors, EGR valve pressure sensors, EGR temperature sensors, EGR valve position sensors, engine exhaust temperature sensors, engine exhaust pressure sensors, and compressor inlet and outlet sensors for temperature and pressure.

The gas turbine engine controller 28 also receives (block 154) the signal 26 from instrumentation 24 representative of the one or more properties of the fuel 54. The one or more properties of the fuel 54 include at least the LHV and the SG of the fuel 54 acquired at the fuel sensing point 58 located upstream of the inlet 13 of the fluidic buffer volume device 12 disposed upstream of the fuel metering system 66 of the fuel consuming system 14. The one or more properties of the fuel 54 may also include percent nitrogen, percent carbon dioxide, specific heat ratio, and/or compressibility. The instrumentation may include the WIM, the gas chromatograph, or any combination thereof. In one embodiment, the signal 26 received from the instrumentation 24 representative of at least the LHV and the SG of the fuel 54 acquired at the fuel sensing point 58 is representative of the LHV and the SG of the fuel 54 as it exits an outlet 15 of the fluidic buffer volume device 12 into the fuel metering system 66 of the fuel consuming system 14.

The gas turbine controller 28 further receives (block 156) the one or more properties of the fluidic buffer volume device 12. The one or more properties of the fluidic buffer volume device 12 may include the effective volume of the fluidic buffer volume device 12 and/or the transport time from the fuel sensing point 58 to the fuel consumption point 64.

The controller 28 then generates (block 158) the time-resolved volumetric grid that characterizes the fuel transport properties for different flow conditions and flow times of the fuel based at least on the one or more properties of the fuel consuming system 14, the LHV and the SG of the fuel 54, and the one or more properties of the fluidic buffer volume device 12. The controller 28 utilizes the time-resolved volumetric grid to send the control signal 68 (block 160) to the fuel metering system 66 and may set a position of the fuel metering valve 70.

Technical effects of the disclosure include systems and methods for fluid transfer (e.g., fuel transfer) that includes instrumentation 24, a fluidic buffer volume device 12, and a controller 28. The controller 28 is able to receive one or more properties of a fluid consuming system (e.g., fuel consuming system 14); a signal 26 from the instrumentation 24 representative of one or more properties of a fluid (e.g., a fuel 54), and one or more properties of the fluidic buffer volume device 12. The controller 28 is able to generate a time-resolved volumetric grid that characterizes fuel transport properties of the fuel 54 for different flow conditions and flow times based at least on the one or more properties of the fuel consuming system 14; the signal 26 from the instrumentation 24 representative of one or more properties of a fuel 54, and the one or more properties of the fluidic buffer volume device 12. Advantageously, the disclosed embodiments provide a faster response time and access to greater allowable error percentage and rate of change capabilities for the fuel consuming system 14 in comparison to the use of instrumentations not linked to the one or more properties of a fuel consuming system 14; the signal 26 from the instrumentation 24 representative of one or more properties of a fuel 54, and the one or more properties of the fluidic buffer volume device 12.

This written description uses examples to disclose the subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a fluid transfer system comprising:
instrumentation configured to measure one or more properties of a fuel;
a fluidic buffer volume device located downstream of a fuel sensing point of the instrumentation, wherein the fluidic buffer volume device is configured to provide a residence time for the fuel within the fluidic buffer volume device to enable a signal from the instrumentation representative of an analysis of the one or more properties of the fuel to be communicated to enable adjustment of operating conditions of a fuel consuming system by a time that the fuel is provided to the fuel consuming system; and
a controller programmed to receive one or more properties of the fuel consuming system, to receive the signal from the instrumentation representative of the one or more properties of the fuel, and to receive one or more properties of the fluidic buffer volume device, and to generate a time-resolved volumetric grid that characterizes fuel transport properties of the fuel for different flow conditions and flow times based at least on the one or more properties of the fuel consuming system, the one or more properties of the fuel, and the one or more properties of the fluidic buffer volume device.

2. The system of claim 1, comprising the fuel consuming system, wherein the fuel consuming system comprises a gas turbine.

3. The system of claim 1, wherein the one or more properties of the fuel consuming system comprise at least one of an engine speed, a load, an intake manifold air temperature, an exhaust gas recirculation temperature, a fuel characteristic, or any combination thereof.

4. The system of claim 1, wherein the controller is configured to utilize the time-resolved volumetric grid to adjust operating conditions of the fuel consuming system with advanced knowledge of the fuel transport properties to schedule consumption of the fuel within operational requirements of the fuel consuming system.

5. The system of claim 1, wherein the instrumentation comprises a Wobbe Index Meter.

6. The system of claim 1, wherein the instrumentation comprises a gas chromatograph.

7. The system of claim 1, wherein the signal is an analog signal.

8. The system of claim 1, wherein the one or more properties of the fuel comprise lower heating value (LHV), specific gravity (SG), percent nitrogen, percent carbon dioxide, specific heat ratio, and compressibility.

9. The system of claim 1, wherein the controller is configured to receive at least the LHV and the SG of the fuel from the signal, and to generate the time-resolved volumetric grid based on the LHV and the SG of the fuel, the one or more properties of the fuel consuming system, and the one or more properties of the fluidic buffer volume device.

10. The system of claim 1, wherein the one or more properties of the fluidic buffer volume device comprise an effective volume of the fluidic buffer volume device and a transport time from the fuel sensing point to a fuel consumption point.

11. The system of claim 1, wherein the fluidic buffer volume device is configured to reproduce a transient event occurring upstream of an inlet of the fluidic buffer volume device in the fuel downstream of the outlet after the fuel travels along a fuel flow path through the fluidic buffer volume device.

12. A system, comprising:
a gas turbine engine controller programmed to receive one or more properties of a gas turbine engine, to receive a signal from instrumentation representative of at least a lower heating value (LHV) and a specific gravity (SG) of a fuel acquired at a fuel sensing point located upstream of an inlet of a fluidic buffer volume device disposed upstream of a fuel metering system of the gas turbine engine, and to receive one or more properties of the fluidic buffer volume device, to generate a time-resolved volumetric grid that characterizes fuel transport properties of the fuel for different flow conditions and flow times based at least on the one or more properties of the gas turbine engine, the LHV and the SG of the fuel, and the one or more properties of the fluidic buffer volume device, and to utilize the time-resolved volumetric grid to provide a control signal to the fuel metering system with advanced knowledge of the fuel transport properties of the fuel to schedule consumption of the fuel within operational requirements of the gas turbine engine.

13. The system of claim 12, wherein the fuel metering system comprises a fuel metering valve, and the gas turbine engine controller is configured to utilize the time-resolved volumetric grid to provide the control signal to set a position of the fuel metering valve.

14. The system of claim 12, wherein the signal received from the instrumentation representative of at least the LHV and the SG of the fuel acquired at the fuel sensing point is representative at least of the LHV and the SG of the fuel as it exits an outlet of the fluidic buffer volume device into the fuel metering system of the gas turbine engine.

15. The system of claim 12, wherein the signal is an analog signal.

16. The system of claim 12, wherein the signal received from the instrumentation is representative of one or more of a percent nitrogen, percent carbon dioxide, specific heat ratio, and compressibility of the fuel.

17. The system of claim 12, wherein the one or more properties of the fluidic buffer volume device comprise an effective volume of the fluid buffer volume device and a transport time from the fuel sensing point to a fuel consumption point.

18. A method, comprising:
receiving, at a gas turbine engine controller, one or more properties of a gas turbine engine;
receiving, at the gas turbine engine controller, a signal from instrumentation representative of at least a lower heating value (LHV) and a specific gravity (SG) of a fuel acquired at a fuel sensing point located upstream of an inlet of a fluidic buffer volume device disposed upstream of a fuel metering system of the gas turbine engine;
receiving, at the gas turbine engine controller, one or more properties of the fluidic buffer volume device;
generating, via the gas turbine engine controller, a time-resolved volumetric grid that characterizes fuel transport properties for different flow conditions and flow times of the fuel based at least on the one or more properties of the gas turbine engine, the LHV and the SG of the fuel, and the one or more properties of the fluidic buffer volume device; and
utilizing, via the gas turbine engine controller, the time-resolved volumetric grid to provide a control signal to the fuel metering system.

19. The method of claim 18, wherein the signal received from the instrumentation representative of at least the LHV and the SG of the fuel acquired at the fuel sensing point is representative of the LHV and the SG of the fuel as it exits an outlet of the fluidic buffer volume device into the fuel metering system of the gas turbine engine.

20. The method of claim 18, wherein the one or more properties of the fluidic buffer volume device comprise an effective volume of the fluid buffer volume device and a transport time from the fuel sensing point to a fuel consumption point.
